(19) United States
(12) Patent Application Publication
(10) Pub. No.: US 2016/0107210 A1
(43) Pub. Date: Apr. 21, 2016

(54) METHOD FOR TREATING SOIL AND GROUNDWATER CONTAINING HEAVY METALS INCLUDING NICKEL

(71) Applicant: REDOX TECHNOLOGY GROUP LLC, Carmel, IN (US)

(72) Inventors: Gary J. Meyer, Indianapolis, IN (US); Thomas P. McCullough, Carmel, IN (US); Anthony J. Kriech, Indianapolis, IN (US); Ralph E. Roper, JR., Carmel, IN (US)

(21) Appl. No.: 14/885,665

(22) Filed: Oct. 16, 2015

Related U.S. Application Data
(60) Provisional application No. 62/065,356, filed on Oct. 17, 2014.

(51) Int. Cl. B09C 1/08; C02F 1/52; B09C 1/02; C02F 1/28

(52) U.S. Cl. CPC B09C 1/08; C02F 1/281; C02F 1/5236; B09C 1/02; C02F 2101/20

(57) ABSTRACT

A method of reducing the mobility of metal contaminates in mediums such as soil, groundwater, sludge, etc. that involves contacting the mediums with a reagent that is a ferrous sulfide suspension that contains at least FeS and Al(OH)₃. The reagent is produced by reacting a solution that contains at least NaAlO₂ and NaOH with a solution that contains FeCl₂, HCl and water to form a reaction mixture that contains Fe²⁺, Cl⁻, Na⁺, Al(OH)₃ and H₂O; and adding NaHS to the reaction mixture. The mobility of the metal contaminates is reduce by adsorption of the metal contaminates in the medium onto the surface of ferrous sulfide or Al(OH)₃ in the ferrous sulfide suspension; adsorption of the metal contaminates in the medium onto iron (hydr)-oxides formed in the suspension; and precipitation of the metal contaminates.

### RELATED APPLICATION

This application is based upon U.S. Provisional Application Ser. No. 62/065,356, filed Oct. 17, 2014 to which priority is claimed under 35 U.S.C. §120 and of which the entire specification is hereby expressly incorporated by reference.

### BACKGROUND

The present invention relates generally to the field of soil and groundwater remediation, more particularly to a method for remediation of soil and groundwater which has become contaminated with various heavy metals including, but not limited to, nickel.

Contamination of soil and groundwater resulting from historically stored, discharged and/or disposed hazardous substances and waste products has resulted in a global effort to identify efficacious and economical treatment methods to mitigate the deleterious effects of this contamination on the public health and to the environment.

The various treatment methods may be broadly categorized into the following categories—(a) “Excavation/Disposal” whereby contaminated soils are excavated and then placed within an engineered disposal facility or unit; (b) “Containment/Isolation” whereby an engineered cap and/or horizontal or vertical barriers are designed or constructed to isolate the contaminated soil or groundwater from the surrounding environment; (c) “Phytoremediation” whereby contaminants are recovered from the soil by plant or foliage uptake; (d) “Vitrification” whereby high-temperature or other thermal treatment mechanisms are used to selectively destroy or volatilize organic materials and the remaining heavy metals become vitrified; (e) “Soil Washing” whereby soils are “scrubbed” or “washed” to remove contaminants by dissolving or suspending targeted contaminants in the wash solution or concentrating the targeted contaminants into a smaller volume of soil by particle size separation, gravity separation, and attrition scrubbing; (f) “Soil Flushing” in which water or other aqueous solution is used to flush soluble contaminants from vadose zone soil and the resulting leachate is recovered from the groundwater and treated (e.g. “pump-and-treat”); (g) “Electrokinetics” in which a direct electrical current is applied to the soil to create a voltage gradient which causes certain heavy metals in soil-water to migrate to the oppositely charged electrode; and (h) “Chemical Treatment” whereby various chemical reagents or amendments are applied to the soil surface or incorporated (mixed) into the contaminated soil to fix, stabilize, or solidify the contamination to prevent contaminants from migrating off-site. This last method may also be known as “geochemical fixation”, “stabilization”, or “inactivation”.

One particular source of soil and groundwater contamination is the result of intentional or unintentional discharges from metal plating operations including electroplating.

Electroplating is a process by which one metal product (e.g. steel) is coated by another metal (e.g. chrome) by chemical or electrochemical processes for the purpose of changing the final product's physical or aesthetic properties (e.g. hardness, corrosion resistance, brilliance). During electroplating a variety of specialty chemicals and additives including, but not limited to, heavy metals, cyanide, volatile organic compounds (VOCs), semi-volatile organic compounds (SVOCs), acids, and caustics are used.

These process chemicals and/or their waste products can enter the environment through spills or leaks from process tanks, sumps and releases during handling of raw materials, air emissions, or waste disposal. Upon discharge to the soil, some of these chemicals or wastes are relatively immobile and will remain in close proximity to their point of discharge. Other chemicals or wastes from plating operations are more mobile and have the potential to impact deeper into the soil or migrate into the groundwater.

Some of these chemicals and/or their waste products may include high concentrations of metals, including but are not limited to, aluminum, antimony, arsenic, barium, boron, cadmium, chromium, copper, iron, lead, manganese, mercury, molybdenum, nickel, selenium, silver, thallium, tin, uranium, vanadium, and zinc.

The aforementioned metals may generally be divided into two groups: those primarily present as divalent cations (e.g. cadmium, copper, lead, mercury, nickel, zinc) and those primarily present as anions or oxyanions (e.g. arsenic, chromium, molybdenum, selenium, uranium). The solubility of each of these metals is dependent upon pH, oxidation-reduction potential (ORP), aqueous concentrations of other interacting or reacting species, the availability of sorption sites, and reaction kinetics.

Copper (Cu) is retained in soils through exchange and specific adsorption mechanisms; however, since Cu has a high affinity for soluble organic and inorganic ligands, the formation of these complexes may greatly increase the mobility of copper in soils.

Zinc (Zn) is readily adsorbed by clay minerals, carbonates, or hydrous oxides. Similar to many cationic metals, zinc adsorption increases with pH. Zinc however may also form complexes with inorganic and organic ligands that will affect its adsorption reactions with soil surfaces.

Cadmium (Cd) may be adsorbed by clay minerals, carbonates or hydrous oxides of iron and manganese, or may be precipitated as cadmium carbonate, hydroxide, and phosphate. The chemistry of Cd in the soil environment is, to a great extent, controlled by pH. Under acidic conditions Cd solubility increases however at pH values greater than 6, cadmium is adsorbed by the soil solid phase or is precipitated.

Arsenic (As) in soil environments exists as either arsenate As⁵⁺ (e.g. AsO₄³⁻), or as arsenite, As³⁺ (e.g. AsO₂⁻). Arsenite is the more toxic form of arsenic and is more soluble than arsenate compounds. The adsorption of arsenite is strongly pH-dependent. Arsenate may form insoluble precipitates with iron, aluminum, and calcium. Both pH and the ORP are important factors in determining the form and fate of arsenic in soil. At high ORP levels, arsentate species predominate. As the pH increases or the ORP decreases, As³⁺ species predominate.

Selenium (Se) primarily exists in the soil environment as selenide (Se²⁻), elemental selenium)(Se⁰), selenite (SeO₃²⁻), and selenate (SeO₄²⁻). Both the concentration and forms of Se are governed by pH, redox, and soil composition. Selenate is more mobile in soils compared to selenite and is the predominant form of selenium in calcareous soils and under alkaline conditions. Selenite is the predominant form in acidic soils. Factors favoring selenium mobility are alkaline pH, selenium concentration, oxidizing conditions, and high concentrations of other anions that strongly adsorb to soils, in particular phosphate. Under reduced conditions, selenium is converted to the elemental form (Se⁰).

Chromium (Cr) primarily exists in two oxidation states in soils—trivalent chromium (Cr³⁺) and hexavalent chromium (Cr⁶⁺). The predominant forms of hexavalent Cr in soils are HCrO₄⁻, CrO₄²⁻, and Cr₂O₇²⁻. Cr⁶⁺ species are more toxic than Cr³⁺ species.

In addition to the difficultly in removing anions or oxyanions that have different solubilities as a function of their oxidation state, removal of cationic contaminants (e.g. Pb²⁺, Cu²⁺, Cd²⁺, Ni²⁺, Zn²⁺) also presents unique challenges to achieve regulatory treatment objectives.

One particularly difficult contaminant to treat in soils and groundwater is nickel.

At low to neutral pH and low Ni concentrations, the mobility of Ni in soils and groundwater is mainly determined by adsorption processes, while at high pH and high Ni concentrations the formation of Ni-containing precipitates like Ni-hydroxides or nickel-aluminum layered double hydroxides (if aluminum is available) are possible. In coarse grained sandy aquifers which contain a relatively lower number of adsorption sites, the high mobility of many heavy metals, including Ni is problematic. Further, the formation of Ni-complexes with both inorganic and organic ligands also increases nickel mobility in soils. The speciation (and mobility) of nickel in soils and groundwater is therefore related to the nickel concentration, matrix pH, the availability of other cationic or anionic species, and the amount and type of available adsorption sites.

Given these numerous possible reactions and interactions, any effective treatment method used to mitigate or remediate metal contamination in soil or groundwater impacted sites must not only be successful in achieving the requisite regulatory goals in the short-term, but must also continue to provide effective treatment when the surface and subsurface conditions return to a steady-state condition.

Since the solubility of each of the aforementioned metals which may be present in soils or groundwater as divalent cations or as oxyanions are dependent upon pH, oxidation-reduction potential (ORP), aqueous concentrations of other reacting species, the availability of sorption sites, and reaction kinetics, the selection of chemical reagents that may promote or inhibit oxidation (or reduction) to more effectively remove one targeted contaminant may have the unintended consequence of increasing the solubility of other contaminants in the soil or groundwater matrix.

The prior art related to addition of chemical reagents for treatment of contaminated soil and groundwater tend to relate to methods of treatment that target particular contaminants (or groups of contaminants) that may be treated in a similar fashion, or require the addition of multiple chemical reagents applied to the contaminated soil or groundwater in a specific sequence or order of addition.

U.S. Pat. No. 5,202,033 to Stanforth et al. describes an in situ method for in-place treatment for leachable materials, including arsenic. The method involves the steps of introducing additives into the waste or soil medium which immobilize the heavy metals by chemical reaction and precipitation in the soil or waste. The treatment is accomplished by adding materials containing phosphates or carbonates. The phosphate- or carbonate-containing materials form insoluble phosphate or carbonate salts with the heavy metals in the soil or wastes such that the heavy metals will not leach.

U.S. Pat. No. 5,252,003 to McGahan discloses a method for the treatment of particulate materials such as soil or sludges, or arsenic-contaminated soil or sludges that involves reacting the arsenic contaminants with a source of iron (III) ions and a source of magnesium (II) ion. In such a manner, any arsenic contaminant is stabilized in situ to minimize its leaching potential.

U.S. Pat. No. 6,258,018 to Pal et al. discloses a method of treating metal-bearing material to stabilize leachable metals comprising the steps of contacting the metal-bearing material with a suspension comprising a first component and a second component to form a mixture, wherein the first component supplies at least one member from the group consisting of sulphates, chlorides, fluorides, magnesium, halides, halites and silicates, and the second component supplies at least one phosphate anion; and curing said mixture for a period of time to form a cured material. The metal-bearing material contains at least one leachable metal selected from the group consisting of lead, aluminum, arsenic (III), barium, bismuth, cadmium, chromium (III), copper, iron, nickel, selenium, silver and zinc.

U.S. Pat. No. 6,623,646 to Bryant et al. discloses a method for converting metal contaminants in soil to less toxic forms as well as permitting their removal from groundwater. A first reactive solution comprising ferrous sulfate and an acid selected from the group consisting of sulfuric acid and phosphoric acid is injected to decomplex contaminants and precipitate them as insoluble compounds. A second reactive solution comprising hydrogen peroxide, and an acid selected from the group consisting of sulfuric acid and phosphoric acid is then injected to destroy organic liquids and enhance decomplexation.

The present invention is an improved and efficient method for chemical remediation of soil and groundwater, and provides a method for remediation of soil and groundwater which has become contaminated with various heavy metals including, but not limited to, nickel by addition of a single chemical reagent.

### BRIEF SUMMARY

According to various features, characteristics and embodiments of the present invention which will become apparent as the description thereof proceeds, the present invention provides a method for reducing the mobility of at least one of nickel and mercury from a medium selected from the group consisting of soil, sediments, groundwater, sludge, and which method comprises providing a reagent that comprises a ferrous sulfide suspension and contacting the medium with the reagent, the reagent being produced by:

a) reacting a solution that contains at least NaAlO₂ and NaOH with a solution that contains FeCl₂, HCl and water to form a reaction mixture that contains Fe²⁺, Cl⁻, Na⁺, Al(OH)₃ and H₂O; and

b) adding NaHS to the reaction mixture of step a) to form a ferrous sulfide suspension that contains at least FeS and Al(OH)₃.

The present invention further provides a chemical reagent for reducing the mobility of at least one of nickel and mercury from a medium selected from the group consisting of soil, sediments, groundwater, sludge and where said reagent comprises a ferrous sulfide suspension that is produced by:

a) reacting a solution that contains at least NaAlO₂ and NaOH with a solution that contains FeCl₂, HCl and water to form a reaction mixture that contains Fe²⁺, Cl⁻, Na⁺, Al(OH)₃ and H₂O; and

b) adding NaHS to the reaction mixture of step a) to form a ferrous sulfide suspension that contains at least FeS and Al(OH)₃.

The present invention further provide a method for reducing the mobility of metal contaminates from a medium selected from the group consisting of soil, sediments, groundwater, sludge, and which method comprises providing a reagent that comprises a ferrous sulfide suspension and contacting the medium with the reagent, the reagent being produced by:

a) reacting a solution that contains at least NaAlO₂ and NaOH with a solution that contains FeCl₂, HCl and water to form a reaction mixture that contains Fe²⁺, Cr, Na⁺, Al(OH)₃ and H₂O; and

b) adding NaHS to the reaction mixture of step a) to form a ferrous sulfide suspension that contains at least FeS and Al(OH)₃.

### BRIEF DESCRIPTION OF THE DRAWINGS

The present invention will be described with reference to the attached drawings which are given as non-limiting examples only, in which:

FIGS. 1a and 1b depict a “single cell” and a “sheet” of FeS, respectively.

FIGS. 2a and 2b depict a “single cell” and a “sheet” of metacinnabar (β-HgS), respectively.

FIG. 3 is a generalized solubility diagram for bayerite generated at 25° C. and 1 atmosphere pressure.

### DETAILED DESCRIPTION OF THE DRAWINGS AND THE PRESENTLY PREFERRED EMBODIMENTS

The present invention is directed to a ferrous sulfide suspension containing aluminum hydroxide, a method for producing the ferrous sulfide suspension containing aluminum hydroxide, and methods for using the ferrous sulfide suspension containing aluminum hydroxide for the treatment and removal of heavy metals from contaminated soil or groundwater. For purposes of the present invention “groundwater” refers to water that is beneath the surface of the ground that originates from rain and melting snow and ice and fills the porous spaces in soil, sediment, rocks and other subterranean matter and is the source of water in aquifers, springs, wells and other subterranean collections of water. More generally “groundwater” refers to water below the land surface in a zone of saturation. The ferrous sulfide suspension containing aluminum hydroxide of the present invention is a minimally soluble, colloidal suspension that can be used to enhance the removal capabilities of heavy metals from contaminated soil or groundwater.

Through a combination of complex chemical reactions, precipitation, co-precipitation, and surface adsorption the ferrous sulfide suspension containing aluminum hydroxide of the present invention can effectively immobilize and/or remove heavy metals from contaminated soil or groundwater.

During the course of the present invention the inventors surprisingly discovered that a liquid suspension containing minimally soluble ferrous sulfide (FeS) and aluminum hydroxide can efficiently and economically immobilize and/or remove heavy metals from contaminated soil and groundwater by both absorption and adsorption mechanisms.

Though the combination of various molar ratios of a ferrous ion source (e.g. FeCl₂), an aluminum ion source (e.g. Al(OH)₃, NaAlO₂), a sulfide ion source (e.g. NaHS), and an alkalinity source (e.g. NaOH), the resulting alkaline liquid suspension containing FeS and aluminum hydroxide particles provides an economical and efficient single reagent for the both the short-term and long-term treatment of soil or groundwater containing various combinations and concentrations of heavy metals.

Since these combinations of various molar ratios of a ferrous ions, aluminum ions, sulfide ions, and an alkalinity source result in an alkaline liquid suspension containing different proportions of the aforementioned ions in equilibrium with any FeS and aluminum hydroxide particles thus formed, the dominant or primary mechanism(s) controlling heavy metals removal soil or groundwater may be different based on the desired specific formulation produced. Therefore, the discussion below of the dominant or primary mechanism(s) believed to control the treatment capability of heavy metals in soil and groundwater should in no way be considered as limiting since those skilled in the art can readily adjust the molar ratios of the ferrous ions, aluminum ions, sulfide ions, and an alkalinity source as desired.

The solubility product constants of selected metal-sulfide species (MeS) is the equilibrium constant for a solid substance dissolving in an aqueous solution based upon the general formula:

MeS₍ₛ₎+H⁺⇄Me²⁺+HS⁻ (1)

In the present invention, ferrous sulfide, sometimes referred to as “mackinawite”, “disordered mackinawite”, “amorphous ferrous sulfide” is formed which may disassociate by the following reaction:

FeS₍ₛ₎+H⁺⇄Fe²⁺+HS⁻ (2)

The solubility product constant (log Kₛₚ) of FeS₍ₛ₎ is many orders of magnitude higher than the solubility product of a number of other metal sulfides including NiS, ZnS, PbS, CdS, SnS, CuS and HgS. Therefore, in the presence of most cationic metals that may be present (or formed) in soils or groundwater, the formation of other metal sulfides over FeS is favored. By providing the sulfide ion in the form of a minimally soluble ferrous sulfide solid particle, only the stoichiometric amount of sulfide from ferrous sulfide dissolution will enter the soil or groundwater that is necessary to precipitate any free cationic metals present.

Concurrent with the equilibrium mechanism controlling the concentration of sulfides released into the soil or groundwater, the same equilibrium mechanism also contributes in controlling the concentration of Fe²⁺ ions in the soil or groundwater.

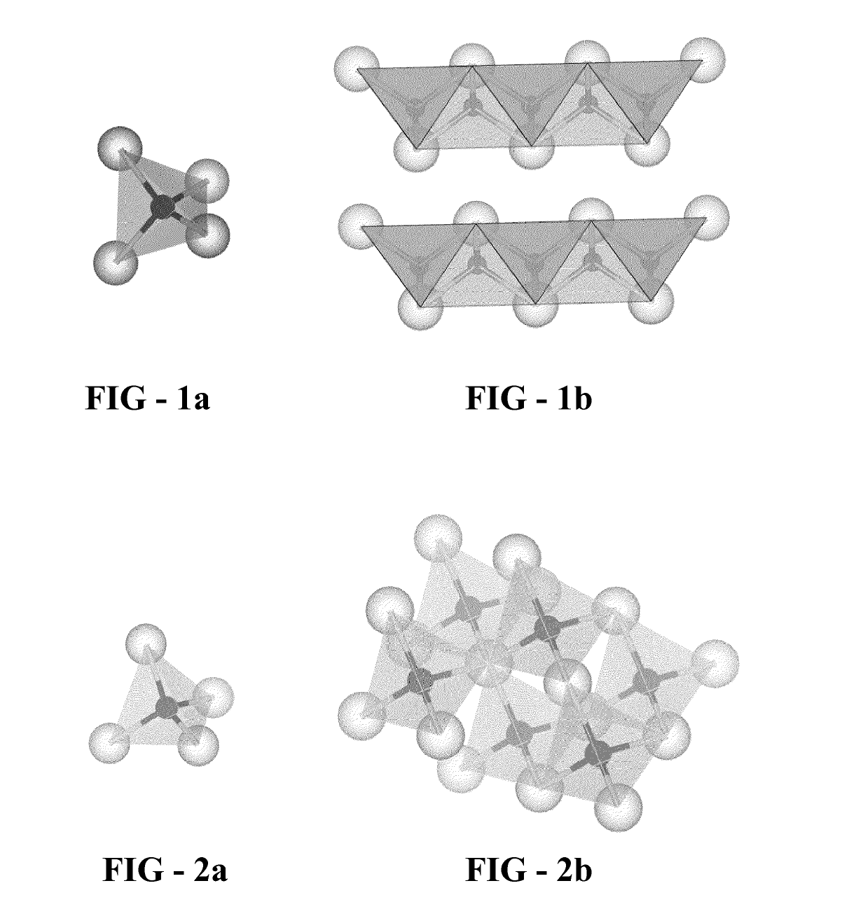

FIGS. 1a and 1b depict a “single cell” and a “sheet” of FeS, respectively. In these figures it is noted that each iron ion is “four-way” coordinated to each sulfur ion.

FIGS. 2a and 2b depict a “single cell” and a “sheet” of metacinnabar (β-HgS), respectively. In these figures it is noted that similar to FeS, each mercury ion is “four-way” coordinated to the sulfur ions.

Although the two structures in FIGS. 1a, 1b and 2a, 2b are very similar, the key difference is that FeS forms into sheets while the metacinnabar (β-HgS) tends to “bulk precipitate” and does not form into “sheets.” Although FIGS. 2a and 2b represent a “single cell” and a “sheet” of metacinnabar (β-HgS), respectively, most other metal sulfides (e.g. PbS, CuS, NiS, ZnS) tend to also “bulk precipitate” and not form into “sheets”.

Mercury and other heavy metals therefore react with and promote dissolution of FeSₘ during the formation of metacinnabar (β-HgS) or other heavy metal sulfides.

In addition to the removal of aqueous Hg²⁺ or other cationic heavy metals by its combination with aqueous sulfide ions to form an insoluble metal sulfide precipitate through absorption, the present invention may also promote removal of aqueous Hg²⁺ or other cationic heavy metals through adsorption to the FeS₍ₛ₎ particle surface.

In “Sorption of Mercuric Ion by Synthetic Nanocrystalline Mackinawite (FeS),” Hoon Y. Jeong, et al., Environ. Sci. Technol. 2007 (41), 7699-7705, the authors concluded that in addition to absorption, an adsorption mechanism also contributes to the removal of Hg²⁺ from aqueous solutions. The removal mechanisms are dependent on the relative concentrations of Hg²⁺ and FeS. When the molar ratio of [Hg²⁺]/[FeS] is as low as 0.05, adsorption is mainly responsible for Hg²⁺ removal. As the molar ratio increases, the adsorption capacity becomes saturated and results in precipitation of HgS. Concurrently with HgS precipitation, the released Fe²⁺ from FeS is resorbed by an adsorption mechanism in the acidic pH range and either adsorption or precipitation as iron (hydr)-oxides at neutral to basic pHs. Subsequently, the iron (hydr)-oxides precipitates formed at neutral to basic pHs may also serve as an adsorbent for Hg²⁺.

Therefore, the proposed mechanisms for binding Hg²⁺ (or other divalent cations) to FeS₍ₛ₎ are believed to involve precipitation as metal sulfides (generally MeS) and Me²⁺ adsorption to the FeS₍ₛ₎ surface (≡FeS) by the following reactions:

FeS₍ₛ₎+Me²⁺⇄MeS+Fe²⁺ (3)

≡FeS+Me²⁺⇄≡FeS-Me²⁺ (4)

As used herein, adsorption is meant to encompass all processes responsible for Me²⁺ accumulation at the solid-liquid interface, including but not limited to surface complexation (at low surface coverage) and surface precipitation (at high surface coverage).

The solubility of oxyanions of arsenic (e.g. AsO₄³⁻, AsO₂⁻), selenium (e.g. Se²⁻, Se⁰, SeO₃²⁻, SeO₄²⁻ and chromium (e.g. CrO₄⁻) are dependent upon pH, oxidation-reduction potential (ORP), aqueous concentrations of other reacting species, the availability of sorption sites, and reaction kinetics.

Since oxidation and reduction reactions may increase or decrease the mobility of these aforementioned oxyanions in soil or groundwater, the mechanism of dissolution or surface-mediated oxidation of the FeS₍ₛ₎ component of the present invention influences these oxidation-reduction reactions.

At acidic pH (≈5) the structural Fe²⁺ in FeS₍ₛ₎ is released into the solution before being oxidized and any released sulfide (e.g., H₂S_{(aq)}) may be rapidly oxidized or volatilized. Since aerobic oxidation of dissolved sulfide proceeds very slowly at pHs<6, following the disappearance of sulfides, the solution-phase oxidation of the Fe²⁺ results in precipitation of Fe³⁺-containing (oxyhydr)oxides. Although not as significant compared with proton-promoted dissolution (Reaction 2), the FeS₍ₛ₎ structure may also be subject to oxidative dissolution, by which, the solid-bound sulfide is also transformed (e.g. S⁽⁰⁾, S²⁺, S⁶⁺, Sₓ) via surface-mediated oxidation.

At alkaline pH (>9.0) and in the presence of oxygen, the Fe²⁺ component of FeS₍ₛ₎ is subject to “surface-mediated oxidation”:

≡Fe²⁺—S→≡Fe³⁺—S→≡Fe³⁺—O (5)

Further, this “surface-mediated oxidation” may produce a “coating” of Fe³⁺ (oxyhdr)oxides on the FeS₍ₛ₎ particle surface which may eventually inhibit solution-phase oxidation. As a result of this Fe³⁺-(oxyhdr)oxide coating formed at this elevated pH, surface-mediated oxidation controls both the dissolution rate and the surface oxidation rate of the FeS₍ₛ₎. The structural Fe²⁺ in FeS₍ₛ₎ may be oxidized before oxidation of the structural sulfide which is opposite to the solution-phase oxidation of FeS₍ₛ₎ by which dissolved Fe²⁺ is oxidized after most of the sulfide is either volatized or oxidized.

These unique oxidation-reduction characteristics of FeS₍ₛ₎ at various pHs and ORP provides the present invention with latitude in promoting or inhibiting those oxidation-reduction reactions that may reduce the mobility of oxyanions in contaminated soil or groundwater.

The present invention further provides for the ability to adjust the initial molar ratios of the ferrous ion source, sulfide ion source, and alkalinity source so as to optimize the overall metal removal efficiency in soil and groundwater. The ability to adjust the concentration of insoluble FeS in suspension, the ability to produce a chemical reagent with specified concentrations of ferrous ions (or sulfide ions) by adjusting the stoichiometry of the feedstocks, pH, or combinations of both provides the present invention with flexibility to customized chemical reagents for treatment of soil and groundwater contaminated with heavy metals.

In addition to the proposed aforementioned mechanisms for removal of heavy metals from soil and groundwater by the iron sulfides (FeS₍ₛ₎) in formulations of the present invention, the presence of aluminum oxides or hydroxides (e.g. amorphous Al(OH)₃₍ₛ₎, gibbsite, bayerite) in formulations of the present invention are also effective in removing heavy metals from soil and groundwater.

According to one embodiment of the present invention, the ferrous sulfide suspension may be produced from a caustic byproduct of an aluminum anodizing facility.

In an aluminum anodizing facility solid aluminum is washed in a NaOH bath as follows:

2Al₍ₛ₎+2NaOH+2H₂O⇄2NaAlO₂+3H_{2(g)} (6)

Eventually the bath becomes saturated with NaAlO₂ at which point aluminum hydroxide (Al(OH)₃) precipitates in accordance with the reaction:

2NaAlO₂+4H₂O⇄2Al(OH)₃₍ₛ₎+2NaOH (7)

Prior to this reaction (7) occurring and fouling the system, the anodizing bath is sent for recycling. For purposes of the present invention, the caustic byproduct is a saturated mixture of NaAlO₂, NaOH and possibly Al(OH)₃₍ₛ₎.

Pickle liquor (primarily a mixture of FeCl₂, HCl and water) is mixed with the requisite amount of the caustic byproduct to achieve a final pH of about 8:

[Fe²⁺+2Cl⁻]+[H⁺+Cl⁻]+[Na⁺+Al³⁺+2O²⁻]+2[Na⁺+OH⁻]+[H⁺+OH⁻]⇄Fe²⁺+3Cl⁻+Al(OH)₃₍ₛ₎+3Na+2OH⁻ (8)

In the resulting mixture, Al(OH)₃₍ₛ₎ may precipitate as amorphous Al(OH)₃, gibbsite, or bayerite; the “NaCl” forms as a result of the “strong acid/strong base reaction”, and the ferrous ion (Fe²⁺) remains predominately in solution.

Sodium hydrosulfide (NaHS) is added to this resulting mixture. Although there are an infinite number of possible reactions, the inventors believe that a variation of reaction (9) is most likely. The amount of aqueous of solid products formed is dependent upon the initial stoichiometric amounts of the reactants and the final pH.

Fe²⁺+Cl⁻+Al(OH)₃₍ₛ₎+3NaCl+2OH⁻+[Na⁺+H⁺+S²⁻]⇄FeS₍ₛ₎+Al(OH)₃₍ₛ₎+4NaCl+H₂O+OH⁻ (9)

Since the solubility of NaCl is high (360 g/L), the sodium and chloride ions most likely remain in the aqueous phase. Upon drying, the NaCl will precipitate as halite (NaCl). The “aluminum hydroxide” fraction is in the form of a precipitate (e.g. amorphous Al(OH)₃₍ₛ₎, gibbsite, bayerite). As stated previously, the FeS₍ₛ₎ formed is sometimes referred to as “mackinawite”, “disordered mackinawite”, “amorphous ferrous sulfide”. Depending upon the stoichiometric amounts of NaHS added there may be excess aqueous sulfide (S²⁻) or ferrous iron (Fe²⁺) in the final product.

The concentration of any individual solid phase is dependent upon numerous environmental factors (e.g. pH, temperature, other ions present, etc.). With respect to the “aluminum hydroxide phase” as it relates to the present invention, at a pH of between 5 and 7, any aluminum hydroxide will be predominately as solid particles given its low solubility product constant (log Kₛₚ approximately −7 to −8)

In “EXAFS Study of Mercury(II) Sorption to Fe— and Al-(hydr)oxides: I. Effects of pH”, Christopher S. Kim, et al., Journal of Colloid and Interface Science 271 (2004), 1-15, and “EXAFS study of mercury(II) sorption to Fe— and Al-(hydr)oxides: II. Effects of Chloride and Sulfate”, Christopher S. Kim, et al., Journal of Colloid and Interface Science 270 (2004), 9-20, Hg²⁺ adsorbs strongly as a corner-sharing bidentate, and edge-sharing bidentate complexes to the Al(O,OH)₆ octahedra that compose the bayerite structure. This adsorption of Hg²⁺ is promoted in the presence of sulfate ions which may be present in soil or groundwater contaminated by heavy metals.

The inventors of the present invention postulate that similar to Hg²⁺, other heavy metals in soil and groundwater form strong corner-sharing bidentate and edge-sharing bidentate complexes to the Al(O,OH)₆ octahedra that compose the bayerite structure.

In “Ni Adsorption and Ni—Al LDH Precipitation in a Sandy Aquifer: An Experimental and Mechanistic Modeling Study”, Inge C. Regelink and Erwin J. M. Temminghoff, Environmental Pollution 159 (2011), 716-721, the authors studied the immobilization of nickel in sandy soils and aquifers.

The authors noted that metal contamination is especially of concern in coarse grained sandy aquifers because of the high mobility of metals in these low reactive soils. At low to neutral pH and low Ni concentrations, the mobility of Ni in soils and aquifers is mainly determined by adsorption processes. Since the formation of Ni—Al LDH is thermodynamically favored over the formation of Ni hydroxide, if Al is available, especially at a pH>7.2, at high pH and high Ni concentrations, the formation of Ni-containing precipitates like Ni—Al LDH (Nickel-Aluminum Layered Double Hydroxide) and Ni-hydroxides dominate Ni speciation.

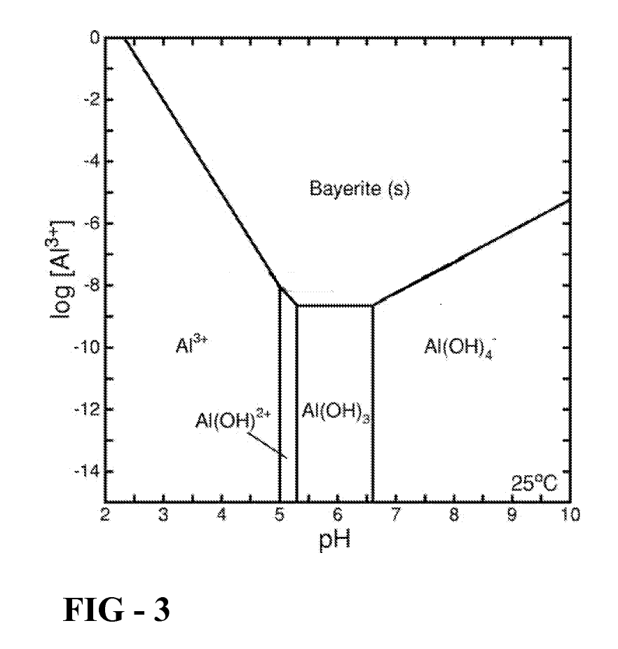

Referring to FIG. 3, the inventors of the present invention postulate that in addition to removal of nickel by strong corner-sharing bidentate and edge-sharing bidentate complexes to the Al(O,OH)₆ octahedra that compose the bayerite structure at pH between 5 and 7.2, nickel immobilization is also possible by the dissolution of bayerite (to provide the necessary Al in the form of Al(OH)₄⁻) to form Ni—Al LDHs at a pH>7.2.

In summary, the present invention provides a multi-faceted approach to immobilization of metals in soil and groundwater. The FeS₍ₛ₎ portion in the ferrous sulfide suspension promotes the formation of metal sulfides (MeS) either by dissolution of FeS₍ₛ₎ to provide the requite sulfide ion, and/or the subsequent re-precipitation as MeS, or via binding of metal cations with sulfhydryl groups on the FeS surface (e.g., ≡FeS-Me). Once this occurs, oxidation and dissolution reactions of the iron sulfides and metal sulfides are significantly reduced. With respect to the Al(OH)₃ portion of the present invention, direct binding of metal cations with the Al(OH)₃ surface is promoted in the presence of sulfate ions.

Features and characteristics of the present invention will be exemplified in the following examples which are provided as non-limiting examples for illustrative purposes only and are not to be considered as limiting.

### EXAMPLE 1

In this Example a treatability study was performed to determine the efficacy of the present invention to treat contaminated soils surrounding a plating wastewater treatment plant sludge land disposal site.

To simulate a saturated in-situ soil environment, soil and groundwater samples from the site were combined at a soil-water ratio of 1:3, by weight, and gently mixed on a stir plate for one hour at room temperature (“1:3 Soil-Water”).

The “1:3 Soil-Water” were then treated at dose rates of 0%, 3%, and 5%, by weight, with a ferrous sulfide suspension containing aluminum hydroxide formulated in accordance with the present invention as follows:

| Feedstock | Composition (% wt) | Final (% wt) |
|---|---|---|
| Pickle Liquor | | 48% to 52% |
| Iron | 9% to 11% | |
| Chlorides | 11% to 14% | |
| Water | 75% to 80% | |
| Caustic Solution | | 26% to 30% |
| Aluminum (as Al(OH)₃) | 14% to 17% | |
| Sodium (as NaOH) | 13% to 19% | |
| Water | 64% to 73% | |
| Sulfide Solution | | 12% to 14% |
| Sulfide | 23% to 25% | |
| Sodium | 16% to 18%) | |
| Water | 57% to 61% | |
| Excess Water H₂O | 8% to 12% | 8% to 12% |

After addition of the ferrous sulfide suspension containing aluminum hydroxide to the formulated to the “1:3 Soil-Water” the dose rates of 0%, 3%, and 5%, by weight, the treated “1:3 Soil-Water” mixture was continued to be gently mixed on a stir plate for one additional hour at room temperature. The samples were then placed in sealed containers, allowed to settle, and 72 hours later, the liquid phase of the treated samples was tested for nickel and other contaminants. The aqueous phase results from this treatability study are summarized in Table 1.

TABLE 1

| | Dose Rate | | |
|---|---|---|---|
| Parameter | 0% | 3% | 5% |
| pH - after 2 hrs | 6.1 | 9.3 | 11.4 |
| ORP - after 2 hrs | +204 | +21 | −331 |
| pH - after 72 hrs | 6.6 | 9.2 | 11.3 |
| ORP - after 72 hrs | +193 | +20 | −299 |
| Cr - Total | ND | ND | ND |
| Cr - Hexavalent | ND | ND | ND |
| Nickel | 170 | 0.1 | 0.14 |
| Zinc | 0.4 | ND | ND |
| Cobalt | 0.1 | ND | ND |
| Copper | 1.6 | 0.01 | ND |
| Manganese | 48 | 0.054 | 0.011 |
| Iron | 0.1 | 0.023 | 0.025 |
| Arsenic | ND | ND | ND |
| Calcium | 360 | 100 | 9.6 |
| Magnesium | 120 | 4.6 | 0.48 |
| Potassium | 53 | 63 | 56 |
| Sodium | 410 | 2000 | 3100 |
| Chlorides | 77 | 1800 | 2900 |
| Sulfates | 2700 | 2000 | 2200 |
| Nitrate- Nitrogen | 1.3 | 1 | 1.1 |
| Chloroform (μg/L) | BDL | BDL | BDL |
| TCE (μg/L) | BDL | BDL | BDL |
| 1,1-DCE (μg/L) | BDL | BDL | BDL |
| MEK | 0.963 | 0.472 | 0.986 |
| Methylene Chloride | 0.0126 | 0.0073 | ND |

(*All data reported as mg/L except pH, ORP (mV), or as indicated.)

### EXAMPLE 2

In this Example a different treatability study was performed to determine the efficacy of the present invention to treat contaminated soils surrounding a currently operating chromium plating site.

To simulate a saturated in-situ soil environment, soil and groundwater samples from the site were combined at a soil-water ratio of 1:3, by weight, and gently mixed on a stir plate for one hour at room temperature (“1:3 Soil-Water”).

The “1:3 Soil-Water” were then treated at dose rates of 0%, 3%, and 5%, by weight, with a ferrous sulfide suspension containing aluminum hydroxide formulated in accordance with the present invention as follows:

| Feedstock | Composition (% wt) | Final (% wt) |
|---|---|---|
| Pickle Liquor | | 42% to 46% |
| Iron | 9% to 11% | |
| Chlorides | 11% to 14% | |
| Water | 75% to 80% | |
| Caustic Solution | | 34% to 36% |
| Aluminum (as Al(OH)₃) | 14% to 17% | |
| Sodium (as NaOH) | 13% to 19% | |
| Water | 64% to 73% | |
| Sulfide Solution | | 10% to 12% |
| Sulfide | 23% to 25% | |
| Sodium | 16% to 18%) | |
| Water | 57% to 61% | |
| Excess Water H₂O | 8% to 12% | 7% to 10% |

After addition of the ferrous sulfide suspension containing aluminum hydroxide to the formulated to the “1:3 Soil-Water” the dose rates of 0%, 3%, and 5%, by weight, the treated “1:3 Soil-Water” mixture was continued to be gently mixed on a stir plate for one additional hour at room temperature. The samples were then placed in sealed containers, allowed to settle, and 72 hours later, the liquid phase of the treated samples was tested for nickel and other contaminants. The aqueous phase results from this treatability study are summarized in Table 2.

TABLE 2

| | Dose Rate | | |
|---|---|---|---|
| Parameter | 0% | 3% | 5% |
| pH - after 2 hrs | 7.2 | 9.2 | 11.1 |
| ORP - after 2 hrs | +28 | +60 | −274 |
| pH - after 72 hrs | 7.0 | 9.0 | 10.8 |
| ORP - after 72 hrs | +28 | +19 | −170 |
| Cr - Total | 0.021 | ND | ND |
| Cr - Hexavalent | 0.002 | ND | ND |
| Nickel | 47 | 0.18 | 0.08 |
| Zinc | ND | ND | ND |
| Cobalt | 0.015 | ND | ND |
| Copper | ND | ND | ND |
| Manganese | 15 | 0.25 | ND |
| Iron | 0.079 | 0.06 | 0.055 |
| Arsenic | ND | 0.011 | 0.011 |
| Calcium | 310 | 210 | 65 |
| Magnesium | 120 | 13 | 0.47 |
| Potassium | 26 | 40 | 39 |
| Sodium | 350 | 2400 | 3600 |
| Chlorides | 67 | 2400 | 4100 |
| Sulfates | 1900 | 2200 | 2300 |
| Nitrate- Nitrogen | 1.3 | 0.66 | — |
| Chloroform (μg/L) | BDL | BDL | BDL |
| TCE (μg/L) | BDL | BDL | BDL |
| 1,1-DCE (μg/L) | BDL | BDL | BDL |
| MEK | 0.0697 | ND | 0.135 |
| Methylene Chloride | ND | ND | ND |

(*All data reported as mg/L except pH, ORP (mV), or as indicated.)

### EXAMPLE 3

In this Example the soil and groundwater surrounding a former chromium plating site contaminated with hexavalent chromium (Cr6+), arsenic (As), antimony (Sb), and nickel (Ni) was treated in-situ with the present invention. The soils were a mixture of clays, sands, and gravel to 15 feet below grade (15′ bgl) to an unconfined aquifer. The saturated thickness ranged between 5 feet to 25 feet across the impacted area.

To remediate the impacted soils, the ferrous sulfide suspension containing aluminum hydroxide formulated in accordance with the present invention as described in Example 1 was incorporated in-situ to a depth of 15′ bgl using a deep augur. Remediation of the groundwater plume was accomplished by an initial injection and a supplemental injection after the approximately one year.

Table 3 is a summary of the levels of soil and groundwater contaminants of concern both pre- and post-treatment. The post-treatment groundwater results shown are from two years (10 calendar quarters) after the initial treatment injection.

TABLE 3

| Metal | Units | Location | Media | Untreated | | Treated |
|---|---|---|---|---|---|---|
| Antimony | | | | | | |
| Sb | mg/L | On-site | Water | 0.012 to | 30 | <0.06 |
| Sb | mg/L | Off-site | Water | BDL to | 4.7 | <0.06 |
| Arsenic | | | | | | |
| Total | mg/kg | On-site | Soil | 14 | | N/A |
| As (SPLP) | mg/kg | On-site | Soil | N/A | | <0.010 |
| As | mg/L | On-site | Water | 0.02 to | 0.36 | |
| | | | | (Avg = 0.10) | | <0.01 |
| As | mg/L | Off-site | Water | BDL to | 0.02 | |
| | | | | (Avg = 0.006) | | <0.01 |
| Chromium | | | | | | |
| Cr⁶⁺ | μg/kg | On-site | Soil | 7,900,000 (max) | | <5.3 |
| Cr⁶⁺ | mg/L | On-site | Water | 4.6 to | 830 | |
| | | | | (Avg = 218) | | <0.01 |
| Cr⁶⁺ | mg/L | Off-site | Water | 0.2 to | 40 | |
| | | | | (Avg = 21) | | <0.01 |
| Nickel | mg/L | On-site | Water | 0.02 to | 50 | <0.05 |
| Nickel | mg/L | Off-site | Water | 0.005 to | 4.1 | <0.05 |

Although the present invention has been described with reference to particular means, materials, and embodiments, from the foregoing description, one skilled in the art can easily ascertain the essential characteristics of the present invention and various changes and modifications can be made to adapt the various uses and characteristics without departing from the spirit and scope of the present inventions as described above and set forth in the attached claims.

1. A method for reducing the mobility of at least one of nickel and mercury from a medium selected from the group consisting of soil, sediments, groundwater, sludge, and which method comprises providing a reagent that comprises a ferrous sulfide suspension and contacting the medium with the reagent, the reagent being produced by:
a) reacting a solution that contains at least NaAlO₂ and NaOH with a solution that contains FeCl₂, HCl and water to form a reaction mixture that contains Fe²⁺, Cl⁻, Na⁺, Al(OH)₃ and H₂O; and
b) adding NaHS to the reaction mixture of step a) to form a ferrous sulfide suspension that contains at least FeS and Al(OH)₃.

2. A method for reducing the mobility of at least one of nickel and mercury from a medium according to claim 1, wherein the solution that contains at least NaAlO₂ and NaOH reacted in step a) comprises a caustic NaOH bath used for washing solid aluminum.

3. A method for reducing the mobility of at least one of nickel and mercury from a medium according to claim 1, wherein the solution that contains at least FeCl₂, HCl and water reacted in step a) comprises a pickle liquor.

4. A method for reducing the mobility of at least one of nickel and mercury from a medium according to claim 1 wherein the reaction mixture of step a) has a pH of about 8.

5. A method for reducing the mobility of at least one of nickel mercury from a medium according to claim 1, wherein the Al(OH)₃ comprises gibbsite, bayerite, amorphous aluminum hydroxides or mixtures thereof.

6. A method for reducing the mobility of at least one of nickel from a medium according to claim 1, wherein the FeS comprises mackinawite, disordered mackinawite, amorphous ferrous sulfide or mixtures thereof.

7. A method for reducing the mobility of at least one of nickel and mercury from a medium according to claim 1, which comprises:
a) contacting the medium with the ferrous sulfide and Al(OH)₃ suspension so as to cause at least one of:
i) adsorption of the at least one of nickel and mercury in the medium onto the surface of ferrous sulfide or Al(OH)₃ in the ferrous sulfide suspension;
ii) adsorption of the at least one of nickel and mercury in the medium onto iron (hydr)-oxides formed in the suspension; and
iii) precipitation of the at least one of nickel and mercury in the medium as a nickel sulfide,
thereby reducing mobility of the at least one of nickel and mercury in the medium.

8. A method for reducing the mobility of at least one of nickel and mercury from a medium according to claim 1, wherein the medium is from a metal plating operation.

9. A method for reducing the mobility of at least one of nickel and mercury from a medium according to claim 8, wherein the medium contains at least one of nickel and mercury in addition to at least one of antimony, arsenic, barium, boron, cadmium, chromium, copper, iron, lead, manganese, molybdenum, selenium, silver, thallium, tin, uranium, vanadium, and zinc.

10. A chemical reagent for reducing the mobility of at least one of nickel and mercury from a medium selected from the group consisting of soil, sediments, groundwater, sludge and where said reagent comprises a ferrous sulfide suspension that is produced by:
a) reacting a solution that contains at least NaAlO₂ and NaOH with a solution that contains FeCl₂, HCl and water to form a reaction mixture that contains Fe²⁺, Cl⁻, Na⁺, Al(OH)₃ and H₂O; and
b) adding NaHS to the reaction mixture of step a) to form a ferrous sulfide suspension that contains at least FeS and Al(OH)₃.

11. A chemical reagent for reducing the mobility of at least one of nickel and mercury from a medium according to claim 10, wherein the solution that contains at least NaAlO₂ and NaOH reacted in step a) comprises a caustic NaOH bath used for washing solid aluminum.

12. A chemical reagent for reducing the mobility of at least one of nickel and mercury from a medium according to claim 10, wherein the solution that contains at least FeCl₂, HCl and water reacted in step a) comprises a pickle liquor.

13. A chemical reagent for reducing the mobility of at least one of nickel and mercury from a medium according to claim 10 wherein the reaction mixture of step a) has a pH of about 8.

14. A chemical reagent for reducing the mobility of at least one of nickel and mercury from a medium according to claim 10, wherein the Al(OH)₃ comprises gibbsite, bayerite, amorphous aluminum hydroxides or mixtures thereof.

15. A chemical reagent for reducing the mobility of at least one of nickel and mercury from a medium according to claim 10, wherein the FeS comprises mackinawite, disordered mackinawite, amorphous ferrous sulfide or mixtures thereof.

16. A chemical reagent for reducing the mobility of at least one of nickel and mercury from a medium according to claim 10, which when the ferrous sulfide and Al(OH)₃ suspension is contacted with the medium at least one of the following occurs:
i) adsorption of the at least one of nickel and mercury in the medium onto the surface of ferrous sulfide or Al(OH)₃ in the ferrous sulfide suspension;
ii) adsorption of the at least one of nickel and mercury in the medium onto iron (hydr)-oxides formed in the suspension; and
iii) precipitation of the at least one of nickel and mercury in the medium as a nickel sulfide,
thereby reducing mobility of the at least one of nickel and mercury in the medium.

17. A method for reducing the mobility of metal contaminates from a medium selected from the group consisting of soil, sediments, groundwater, sludge, and which method comprises providing a reagent that comprises a ferrous sulfide suspension and contacting the medium with the reagent, the reagent being produced by:
a) reacting a solution that contains at least NaAlO₂ and NaOH with a solution that contains FeCl₂, HCl and water to form a reaction mixture that contains Fe²⁺, Cl⁻, Na⁺, Al(OH)₃ and H₂O; and
b) adding NaHS to the reaction mixture of step a) to form a ferrous sulfide suspension that contains at least FeS and Al(OH)₃.

18. A method for reducing the mobility of metal contaminates from a medium according to claim 17, wherein the metal contaminates comprise at least one of aluminum, antimony, arsenic, barium, boron, cadmium, chromium, copper, iron, lead, manganese, mercury, molybdenum, nickel, selenium, silver, thallium, tin, uranium, vanadium and zinc.

19. A method for reducing the mobility of metal contaminates from a medium according to claim 18, wherein the mobility of the metal contaminates is reduced by at least one of:
i) adsorption of the metal contaminates in the medium onto the surface of ferrous sulfide or Al(OH)₃ in the ferrous sulfide suspension;
ii) adsorption of the metal contaminates in the medium onto iron (hydr)-oxides formed in the suspension; and
iii) precipitation of the metal contaminates in the medium as a metal sulfide.

20. A method for reducing the mobility of metal contaminates from a medium according to claim 18, wherein the solution that contains at least NaAlO₂ and NaOH reacted in step a) comprises a caustic NaOH bath used for washing solid aluminum and the solution that contains at least FeCl₂, HCl and water reacted in step a) comprises a pickle liquor.
